(19) United States
(12) Patent Application Publication
(10) Pub. No.: US 2021/0345607 A1
(43) Pub. Date: Nov. 11, 2021

(54) MICROEMULSION FORMULATION CONTAINING CLACYFOS HERBICIDE, PREPARATION METHOD THEREFOR AND USE THEREOF

(71) Applicant: Central China Normal University, Wuhan (CN)

(72) Inventors: Hongwu He, Wuhan (CN); Xiaosong Tan, Wuhan (CN); Hao Peng, Wuhan (CN)

(73) Assignee: Central China Normal University, Wuhan (CN)

(21) Appl. No.: 17/278,039

(22) PCT Filed: Sep. 2, 2019
(86) PCT No.: PCT/CN2019/103938

§ 371 Date: Mar. 19, 2021

(30) Foreign Application Priority Data
Sep. 21, 2018 (CN) 201811107857.8

(51) Int. Cl. A01N 25/04; A01N 25/30; A01N 57/22; A01P 13/00

(52) U.S. Cl. CPC A01N 25/04; A01P 13/00; A01N 57/22; A01N 25/30

(57) ABSTRACT

In the technical field of plant protection, a microemulsion formulation containing clacyfos herbicide, a preparation method therefor, and the use thereof are disclosed. The microemulsion formulation comprises clacyfos, an environment-friendly solvent and a surfactant. The microemulsion formulation has a particle radius of 0.01 μm to 0.1 μm and a pH value of 5 to 7. The microemulsion formulation containing clacyfos herbicide has good dispersibility, small particle size and strong permeability, being a novel green and environment-friendly pesticide formulation.

### TECHNICAL FIELD

The invention relates to the technical field of plant protection, in particular to a microemulsion formulation containing a clacyfos herbicide, a preparation method theref or and an use thereof.

### BACKGROUND

Clacyfos (HW02): the compound has a chemical name of O, O-dimethyl-1-(2, 4-dichlorophenoxyacetoxy) ethyl phosphonate and a molecular formula of C₁₂H₁₅Cl₂O₆P. Clacyfos is a novel herbicide with the property right of the independent intellectual property of China, which is developed by Central China Normal University, belongs to a1—(substituted phenoxyacetoxy)alkylphosphonate and is a strong inhibitor of pyruvate dehydrogenase. The clacyfos has the characteristics of novel structure, high activity, wide weed control spectrum, strong systemic property, low toxicity, low residue and environmental ecological safety. The clacyfos is the only practical herbicide which takes pyruvate dehydrogenase as a target at present. The clacyfos has a brand-new action target, so that the clacyfos is very sensitive to some resistant weeds (such as the resistance of the descurainia sophia to tribenuron methly is very serious) and shows excellent control effect.

The clacyfos as selective herbicide can prevent and kill broad leaf weed, sedge weed and partial monocotyledonous weed in monocotylous crop fields of wheat, corn, rice, etc., it can be also used in lawn, tea garden, orchard and non-cultivated land, etc.

However, as a new herbicide variety, the agricultural application technology for clacyfos is still incomplete, and its dosage form is single. As a result, the exploration and expansion of the application range of the clacyfos, and the development of an environment-friendly preparation thereof are one of important promotion targets for the popularization and application of the clacyfos at present.

### SUMMARY OF THE INVENTION

The invention aims to provide a microemulsion formulation containing a clacyfos herbicide, a preparation method therefor and an use thereof.

The microemulsion formulation containing the clacyfos herbicide has good dispersibility, small particle size and strong permeability. The microemulsion takes water as a medium, which is safe and economical, and it is a novel green environment-friendly pesticide preparation. The microemulsion has the advantages of reduced dosage and high control effect compared with the traditional dosage form, which can lightens the burden of the environment and is beneficial to the safety of people, livestock, other organisms and environmental ecology, it meets the requirement of sustainable development.

In order to achieve the above objects, the present invention provides a microemulsion formulation containing a clacyfos herbicide, which contains the clacyfos, an environmentally friendly solvent and a surfactant, it has a particle radius of 0.01 μm to 0.1 μm and a pH of 5 to 7. In a second aspect, the present invention provides a method for preparing the above microemulsion formulation, the method comprising: mixing and stirring the clacyfos, the environment-friendly solvent, the surfactant and the optional synergistic additive to form transparent homogeneous liquid, and then adjusting the pH value to 5 to 7.

The third aspect of the invention provides the application of the microemulsion formulation in preventing and killing agricultural weeds.

Compared with the prior art, the invention has the following advantages and effects: The solvents in the traditional missible oil preparation mostly adopt aromatic solvents such as dimethylbenzene, methylbenzene and the like, which have high toxicity and are harmful to the environment, and are forbidden and limited to use at present. The invention uses environment-friendly solvent which has low toxicity to human, livestock and other organisms, has no residual hazard and is easy to degrade in the environment.

Moreover, the microemulsion formulation containing the clacyfos herbicide disclosed by the invention takes water as a medium, it is good in dispersibility, small in particle size, strong in permeability, safe and economical. This is a novel green and environment-friendly pesticide preparation. Compared with the traditional dosage form, the microemulsion formulation increases the absorption of weeds to the pesticide, reduces the dosage, improves the control effect and lightens the burden of the environment. Therefore, it is beneficial to the safety of people, livestock, other organisms and environmental ecology, meeting the requirement of sustainable development, and which is the development direction of the current pesticide dosage form.

In addition, the invention is directed at the application and development of the microemulsion formulation containing the clacyfos herbicide as the herbicide for gramineous crop fields such as corn, wheat and rice, and gramineous lawn, orchards, tea gardens and non-cultivated lands. The experimental results show that the clacyfos microemulsion has good permeability, spreadability, absorption and conduction performance, and it has quick action and persistence. In addition, the microemulsion gramineous containing the clacyfos herbicide also has the advantages of high control effect, wide weeding spectrum and capability of improving the yield of experimental crops.

### DETAILED DESCRIPTION

The endpoints of the ranges and any values disclosed herein are not limited to the precise range or value, and these ranges or values should be understood to encompass values close to these ranges or values. For numerical ranges, each range between its endpoints and individual point values, and each individual point value can be combined with each other to give one or more new numerical ranges, and such numerical ranges should be construed as specifically disclosed herein.

The microemulsion formulation containing the clacyfos herbicide contains the clacyfos, an environment-friendly solvent and a surfactant.

In the present invention, the microemulsion formulation has a particle radius of 0.01 μm to 0.1 μm, and specifically, may have, for example, 0.01 μm, 0.02 μm, 0.03 μm, 0.04 μm, 0.05 μm, 0.06 μm, 0.07 μm, 0.08 μm, 0.09 μm, 0.1 μm, or any value in a range of any two of these values. Preferably, the microemulsion formulation has a particle radius of 0.03 μm to 0.08 μm.

In the present invention, the pH of the microemulsion formulation is preferably 5 to 7. In the present invention, when the particle radius and the pH of the microemulsion formulation satisfy the above ranges, the microemulsion formulation has physical and chemical stability satisfying the performance requirements of pesticides, and the decomposition rate of it is less than 5% to 10%.

In the microemulsion formulation according to the present invention, the content of the clacyfos may be 10 wt % to 80 wt %, and specifically, for example, may be 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, or any value in a range of any two of these points. Preferably, it is 15 wt % to 75 wt %, more preferably 20 wt % to 75 wt %, still more preferably 25 wt % to 75 wt %, and still more preferably 25 wt % to 55 wt %.

In the microemulsion formulation of the present invention, the content of the environmentally friendly solvent may be 20 wt % to 80 wt %, preferably 30 wt % to 70 wt %.

In the microemulsion formulation of the present invention, preferably, the environmentally friendly solvent includes water and an organic solvent selected from at least one of a vegetable oil solvent, a coal tar cracking product, a petroleum cracking solvent and a synthetic environmentally friendly solvent. Further preferably, the organic solvent is selected from at least one of biodiesel, solvent oil, liquid paraffin oil, deodorized kerosene, straight-chain alkanes, dimethyl carbonate, N-methylpyrrolidone, propylene glycol monomethyl ether, cyclohexanone, and ethylene glycol. In the microemulsion formulation of the present invention, the surfactant may be contained in an amount of 5 wt % to 30 wt %, preferably 5 wt % to 20 wt %.

In the microemulsion formulation of the present invention, preferably, the surfactant is selected from at least one of alkylsulfonate, alkylarylsulfonate, alkylsulfate, sulfate, polyether, alkylarylether, polyoxyethylene derivative, polyethylene glycol ether, sorbitol monooleate derivative, polyhydric alcohol ester and sugar alcohol derivative.

The polyoxyethylene derivative may be at least one selected from alkylphenol ethoxylates, polyoxyethylene castor oil, polyoxyethylene fatty acid esters, polyoxyethylene sorbitan, polyoxyethylene xylitol anhydride, styrylphenol ethoxylates, tristyrylphenol ethoxylates, polyoxyethylene ethyl ether and polyoxyethylene distyrenated phenyl ether. The sugar alcohol derivative may be selected from at least one of glyceryl monostearate, polysorbate 80, sorbitol acetal, pentabutoxy ether mannitol, mannitol dianhydride, and polysorbate 20. In a specific embodiment, the surfactant can be a commercially available product, such as emulsifier 0203B, emulsifier Berol 9960, emulsifier Berol 9968, emulsifier OP-10, emulsifier OS, emulsifier 600, emulsifier 500, emulsifier 1602, emulsifier E1310. In the microemulsion formulation, the surfactant may also act as a stabilizer and/or antifreeze.

In a preferred embodiment of the present invention, the microemulsion formulation further contains a synergist. The content of the synergist may be 0.1 wt % to 10 wt %, preferably 1 wt % to 5 wt %. More preferably, the synergist is selected from at least one of silicones, esterified vegetable oils (such as methyl-esterified vegetable oils or ethyl-esterified vegetable oils), esterified polyoxyethylene glycerols, methylated polyoxyethylene fatty acids, ethoxylated castor oils, ethoxylated fatty amines, tallow amine polyoxyethylene esters, polycarboxylates, alkyl naphthalene sulfonates, phosphate esters, carboxylic copolymers, comb polymers, fatty alcohol polyoxyethylene ethers and phosphate amine salts. The microemulsion formulation containing the synergist can be used for preventing and killing monocotyledonous and dicotyledonous weeds in tea gardens, orchards or non-cultivated lands.

In the present invention, the microemulsion formulation may further contain a co-solvent and/or a co-surfactant, which are conventional in the art.

The microemulsion formulation containing the clacyfos herbicide can be prepared according to the following method. Specifically, the method comprises the following steps: mixing and uniformly stirring the clacyfos, the environment-friendly solvent, the surfactant and the optional synergist in proportion to form transparent homogeneous liquid, and then adjusting the pH value to 5 to 7. According to the method, the microemulsion with the content of the clacyfos more than 25 wt % can be obtained.

In the method, the synergist can be added in the preparation process by adjusting the intersolubility and the content, and the necessary synergist can be conveniently added by adopting a barrel mixing method in the use process.

The invention also provides use of the microemulsion formulation containing the clacyfos herbicide in preventing and killing agricultural weeds. In the use process, the dosage of the clacyfos can be 150 g/hm² to 800 g/hm², specifically, for example, 150 g/hm², 200 g/hm², 250 g/hm², 300 g/hm², 350 g/hm², 400 g/hm², 450 g/hm², 500 g/hm², 550 g/hm², 600 g/hm², 650 g/hm², 700 g/hm², 750 g/hm², 800 g/hm², or any value in a range of any two of these values. Preferably, the amount of the clacyfos in the use process is 300 g/hm² to 600 g/hm², and more preferably 350 g/hm² to 500 g/hm².

In the present invention, the agricultural weeds could be under control at least one of weeds in gramineous crop fields such as gramineous lawn, wheat, corn, rice, and the like, as well as orchards, tea gardens, and non-cultivated lands. Preferably, the agricultural weeds are Descurainia Sophia(L.) Schur, Lapsana apoqonoides Maxim, Ranunculus japonicus Thunb., Polygonum capitatumBuch.-Ham. ex D. Don, Polygonum aviculare, Polygonum hydropiper L., Chen opodium album (L.), Amaranthus retroflexus L., Portulaca oleracea, Acalypha australis L., Parthenocissus tricuspidata(Sieb. & Zucc.) Planch., Abutilon theophrasti, Eclipta prostrata, Mala chium aquaticnm (L.) Fries, Amaranthus ascendens, Amaranthusthus retroflexus, Commelina communis, Cephalanoplos segetum, Ipomoea heperacea, Pharbitispurpurea (L.) Voisgt, Mazus japonicus, Potentilla supina L., Cyperus difformis L., ElsholtziaWilld, Erigeronbonariensis, Amaranthus spinosus L., Brassica juncea(L.) Czern. et Coss., Eclipta prostrata, Polygonum, Chenopodium serotinum L., Vicia sativa L., Cyperus iria, Leptochloachinesis, Alternanthera philoxeroidis, Humulus scandens Merr, Euphorbia maculate L., Rotala indica, Ammannia rotundifolia Roxb, Lindernia procumbens, Xanthium sibiricum Patrin ex Widder, Convolvulus arvensis L., Eclipta prostrata, Juncellus serotinus, Ludwigiaprostrata Roxb., Ammannia arenarid H., Ammannia baccifera L., Monochoria vaginalis, Mllrdanniatriguetra (Wal1.) Brijckn, Cayratia japonica, Duchesen indica Focke, Cirsium japonicum, Achyranthes bidentata Bl., Amaranthus retroflexus, Capsella bursa pastoris (L.) Medic, Cyperusrotundus, Polygonum perfoliatum L., Artemisia annua, Arthraxon hispidus, Sagittaria pygmaea, Alisma plantago-aquaticaLinn., Sagittaria trifolia L., Marsilea quadrifolia L., Potamogeton distinctus, Spirodela polyrhiza (L) Schleid. Lemna polyrhiza L., Fimbristylis miliacea (L.) Vahl, Galium aparine L. Var. tenerum (Gren. Et Godr) Rc bb, Euphorbia helioscopia L., Veronica didyma Tenore, Buglossoides arvense, Silene conoidea L., Lamium amplexi-caule L., Geranium Carolinianum L., Hemistepta lyrataBge, Solanum nigrum L., Physalis angulata, Origanum vulgare L., Physalis angulata, Eleusine indica, Imperata cyllndrlca, Digitaria Sanguinalis scop, Equisetum arvenense. The microemulsion formulation has safety on tall fescue and zoysia japonica in gramineous lawn, wherein the zoysia japonica is transition type lawn grass which is distributed in wide areas of northeast China, Shandong China, east China and south China, and is an excellent sports field lawn grass seed in most areas of China. Tall fescue is one of main varieties of cold-season type grass mainly applied to lawns in northern China, and the planting area of the tall fescue in China is large. The microemulsion formulation can be used in winter wheat fields and spring wheat fields, wherein stems and leaves are sprayed from the 3 to 5 leaf stage to the tillering stage of wheat, so that the microemulsion formulation has a good weeding effect and is safe to wheat. The microemulsion formulation is used for carrying out spray treatment on stems and leaves of corns in the 3 to 5 leaf stage, so that the microemulsion formulation has a good weeding effect and is safe to the corns.

The microemulsion formulation is used for spraying the stems and leaves after the rice leaves of the rice direct-seeding field are 4 leaves or after the transplanted rice survives, so that the microemulsion formulation has good weeding effect, particularly has excellent control effect on malignant broadleaf weeds in the rice field, such as monochoriapauciflora, murdannia triguetra and the like, and it is still safe for the rice when being used under the condition of higher temperature.

The microemulsion formulation has excellent weeding effect after stems and leaves spray treatment in the seedling stage or 1 to 6 leaf stage of broadleaf weeds.

The microemulsion formulation can be applied to orchards and tea gardens, it not only can prevent and kill broadleaf weeds, but also can prevent and kill monocotyledonous weeds under higher dosage, and it is safe for fruit trees and tea trees.

The crops described above are merely illustrative of the type of crop field to which the clacyfos of the present invention is applied and should not be interpreted as limiting the scope of crops to which the clacyfos is applied.

The present invention will be described in detail below by way of examples. It should be understood that the detailed description and specific examples, while indicating the preferred embodiment of the invention, are given by way of illustration and explanation only, not limitation.

### Preparation Examples A1-A11

Preparing a 10% clacyfos microemulsion: adding the original drug of clacyfos, the emulsifier and the organic solvent, fully stirring and uniformly mixing, adding water, stirring to form transparent homogeneous liquid, and then adjusting the pH to 6.

TABLE 1

| Raw material | A1 | A2 | A3 | A4 | A5 |
|---|---|---|---|---|---|
| Clacyfos | 10% | 10% | 10% | 10% | 10% |
| Emulsifier 0203B | 20% | — | — | — | 10% |
| Emulsifier Berol 9960 | — | 20% | — | 12% | — |
| Emulsifier Berol 9968 | — | — | 20% | 8% | 10% |
| Cyclohexanone | 10% | 10% | 10% | 10% | — |
| Ethylene glycol | 8% | 8% | 10% | 10% | 20% |

| | |
|---|---|
| Water | make up to 100% |

Preparing a 30% clacyfos microemulsion: adding the original drug of clacyfos and the emulsifier, fully stirring and uniformly mixing, adding any one of N-methyl pyrrolidone, propylene glycol methyl ether, biodiesel or dimethyl carbonate, stirring to form transparent homogeneous liquid, and then adjusting the pH to 6.

TABLE 2

| Raw material | A6 | A7 | A8 | A9 | A10 | A11 |
|---|---|---|---|---|---|---|
| Clacyfos | 30% | 30% | 30% | 30% | 30% | 30% |
| EmulsifierOP-10 | — | — | — | 9% | — | 9% |
| EmulsifierOS | — | — | 3% | 3% | 3% | — |
| Emulsifier600 | — | 9% | 9% | — | — | — |
| Emulsifier500 | 3% | 3% | — | — | — | — |
| Emulsifier1602 | 7% | — | — | — | — | 5% |
| EmulsifierE1310 | — | — | — | — | 9% | — |
| Propylene glycol | — | — | make up | — | — | — |
| methyl ether | | | to100% | | | |
| N-methyl | make up | make up | — | — | — | — |
| pyrrolidone | to100% | to100% | | | | |
| Biodiesel | — | — | — | — | make up | make up |
| | | | | | to100% | to100% |
| Dimethyl carbonate | — | — | — | make up | — | — |
| | | | | to100% | | |

The field pesticide effect calculation calculates the plant control effect and fresh weight control effect according to a formula in ‘pesticide field pesticide effect test criterion (I)’.

Control effect (%)=(treatment zone weed decline rate-control zone weed decline rate)/(100−control zone weed decline rate)×100;

Fresh weight control effect (%)=fresh weight of weeds in treatment area/fresh weight of weeds in control area×100.

### Application Example B1

Field efficacy test of 10% clacyfos microemulsion for preventing and killing weeds in corn field

The weeds in the test field mainly comprise Amaranthus retroflexus, Portulaca oleracea and Acalypha austrahs L., and additionally, a small amount of Eclipta prostrata, Abutilon theophrasti and Cirsium setosum (Md.) MB. In the 2 to 4 leaf period of broadleaf weeds and the 3-leaf period of corns, the water content was added to 450 liters/hm². The spraying was carried out once by the stems and leaves after the seedlings of the corns, and the result determination was carried out after 30 days. The 10% clacyfos microemulsion was prepared according to preparation example A1 in the dosage range of 225 g/hm² to 675 g/hm². Wherein, the experimental corn variety is ‘zhengdan 958’. The results of the experiment are shown in Table 3.

TABLE 3

| | | Weed numbers | Fresh weight | |
|---|---|---|---|---|
| | Dosage | control effect | control effect | Corn yield |
| Number | (g/hm²) | (%) | (%) | (kg/20 m²) |
| 1 | 225 | 75 | 94 | 12.97 |
| 2 | 375 | 88 | 98 | 13.00 |
| 3 | 450 | 92 | 99 | 13.05 |
| 4 | 525 | 93 | 99 | 13.07 |
| 5 | 675 | 94 | 99 | 13.60 |

### Application Example B2

### Safety Evaluation of 30% Clacyfos Microemulsion on Turfgrass

The 30% clacyfos microemulsion was used for evaluating the safety of 4 to 5 leaf period of old turfgrass tall fescue and zoysia japonica, and the safety is expressed by inhibiting effect. Wherein 0% inhibition means no toxic effect on the plant and 100% means complete inhibition of plant activity or plant death. The 30% clacyfos microemulsion was prepared according to preparation example A6 in the dosage range of 225 g/hm² to 1800 g/hm². The results are shown in Table 4.

TABLE 4

Inhibiting effect (%)

| Dosage (g/hm²) | Tall fescue | Zoysia japonica |
|---|---|---|
| 225 | 0 | 0 |
| 450 | 0 | 0 |
| 900 | 0 | 0 |
| 1350 | 0 | 20 |
| 1800 | 20 | 40 |

### Application Example B3

### Field Safety Evaluation of 30% Clacyfos Microemulsion on Tall Fescue of Cold-Season Turfgrass

The field safety of the microemulsion on tall fescue of cold-season turfgrass was judged by its ornamental quality. The excellent ornamental quality is shown in that the plants have no phytotoxicity symptom, good growth vigor, normal leaf color and no obvious difference compared with clear water control. The 30% clacyfos microemulsion was prepared according to preparation example A7, and the dosage range is 900 g/hm² to 2700 g/hm². The results of the experiment are shown in Table 5 below.

TABLE 5

| Treatment | | | | | Control | Clear water |
|---|---|---|---|---|---|---|
| (g/hm²) | 900 | 1350 | 1800 | 2700 | agent | control |
| Ornamental quality | good | good | good | good | good | good |

### Application Example B4

### Field Efficacy Test of 30% Clacyfos Microemulsion Against Tall Fescue Lawn Weeds

In Shanghai, Beijing, Shandong, Henan, Shaoxing, Hangzhou and Maanshan, etc., 30% clacyfos microemulsion was used for preventing and controlling weeds in tall fescue lawn weeds. For example, after 21 days of May application, the results show that it is effective in controlling broadleaf weeds in tall fescue lawn weeds. The results of the experiment are shown in Table 6. The 30% clacyfos microemulsion was prepared according to preparation example A8, and the dosage range is 270 g/hm² to 810 g/hm².

TABLE 6

| | Weed control effect (%) | | | | | | | | | |
|---|---|---|---|---|---|---|---|---|---|---|
| | Amaranthus | | Ipomoea | | Amaranthus | | Chenopodium | | Total control | |
| | retroflexus | | heperacea | | ascendens | | serotinum L. | | effect | |
| | Fresh | Weed | Fresh | Weed | Fresh | Weed | Fresh | Weed | Fresh | Weed |
| | weight | numbers | weight | numbers | weight | numbers | weight | numbers | weight | numbers |
| Dosage | control | control | control | control | control | control | control | control | control | control |
| g/hm² | effect | effect | effect | effect | effect | effect | effect | effect | effect | effect |
| 270 | 94 | 95 | 100 | 100 | 93 | 90 | 94 | 90 | 95 | 94 |
| 405 | 97 | 98 | 100 | 100 | 99 | 95 | 98 | 97 | 99 | 98 |
| 540 | 100 | 100 | 100 | 100 | 100 | 100 | 100 | 100 | 100 | 100 |
| 810 | 100 | 100 | 100 | 100 | 100 | 100 | 100 | 100 | 100 | 100 |

### Application Example B5

### Safety Test of 30% Clacyfos Microemulsion on Cereal Crops

The 30% clacyfos microemulsion was a selective stem-leaf herbicide on cereal crops such as rice, wheat and corn. Wherein, the experimental summer corn variety wasluyuandan 14′. The 30% clacyfos microemulsion was formulated according to preparation example A9 in a dosage range of 0 to 1800 g/hm². The results are shown in Table 7.

TABLE 7

| | Wheat (stem-leaf) | | | Rice (stem-leaf) | | | Corn (stem-leaf) | | |
|---|---|---|---|---|---|---|---|---|---|
| | Plant | | | Plant | | | Plant | | |
| Dosage | height | Inhibition | Visual | height | Inhibition | Visual | height | Inhibition | Visual |
| g/hm² | (mm) | % | inspection | (mm) | % | inspection | (mm) | % | inspection |
| 0 | 299.1 | 0 | 0 | 180.3 | 0 | 0 | 370.2 | 0 | 0 |
| 225 | 296.5 | 0.9 | 0 | 180.1 | 0.1 | 0 | 370.9 | −0.2 | 0 |
| 450 | 299.3 | 0 | 0 | 177.4 | 1.6 | 0 | 393.3 | −6.2 | 0 |
| 675 | 305.5 | −2.2 | 0 | 186.2 | −3.3 | 0 | 372.4 | −0.6 | 0 |
| 1350 | 294.9 | 1.4 | 0 | 187.3 | −3.9 | 0 | 362.2 | 2.2 | 0 |
| 1575 | 273.7 | 8.5 | 10 | 179.2 | 0.6 | 0 | 353.6 | 4.5 | 15 |
| 1800 | 269 | 10.1 | 20 | 178 | 1.3 | 10 | — | — | — |

### Application Example B6

### Field Efficacy Test of 30% Clacyfos Microemulsion Against Broadleaf Weeds in Wheat Field

The test was carried out in the wheat 3 leaf period in middle November, and the control experiment was carried out on broadleaf weeds in the wheat field by using 30% of clacyfos microemulsion for 90 days. The 30% clacyfos microemulsion was prepared according to preparation example A10, and the dosage range is 180 g/hm² to 720 g/hm². The results are shown in Table 8.

TABLE 8

| | Weed control effect (%) | | | | | | | | | |
|---|---|---|---|---|---|---|---|---|---|---|
| | | | | | Galium aparine L. Var. | | | | | |
| | Capsella bursa-pastoris | | Veronica | | tenerum (Gren. Et | | Lamium amplexi- | | Descurainia Sophia | |
| | (L.) Medic | | didyma Tenore | | Godr) Rc bb | | caule L. | | (L.) Schur | |
| | Fresh | Weed | Fresh | Weed | Fresh | Weed | Fresh | Weed | Fresh | Weed |
| | weight | numbers | weight | numbers | weight | numbers | weight | numbers | weight | numbers |
| Dosage | control | control | control | control | control | control | control | control | control | control |
| g/hm² | effect | effect | effect | effect | effect | effect | effect | effect | effect | effect |
| 180 | 94 | 95 | 82 | 82 | 90 | 70 | 96 | 88 | 95 | 84 |
| 360 | 98 | 98 | 95 | 95 | 96 | 78 | 97 | 97 | 99 | 90 |
| 450 | 98 | 98 | 97 | 96 | 97 | 80 | 98 | 97 | 99 | 95 |
| 540 | 97 | 98 | 98 | 97 | 96 | 80 | 98 | 98 | 97 | 96 |
| 720 | 99 | 100 | 99 | 99 | 98 | 90 | 99 | 99 | 98 | 97 |

### Application Example B7

### Field Efficacy Test of 30% Clacyfos Microemulsion Against Weeds in Wheat Field

The weeds in the test field mainly comprise Descurainia Sophia (L.) Schur, Capsella bursa-pastoris (L.) Medic and Stellaria media (L.) Cyr, and a small amount of Avena fatua L. and Galium aparine L. Var. tenerum (Gren. Et Godr) Rc bb. Spraying the stems and leaves of the weeds at the 4 to 6 leaf stage and after the wheat was turned green or at the 3 to 5 leaf stage of the wheat once, adding water with the amount of 450 liters/hm², and determining the result after 50 days of experiments. The 30% clacyfos microemulsion was prepared according to preparation example A11, and the dosage range is 300 g/hm² to 600 g/hm². The results are shown in Table 9.

TABLE 9

| | | | | Increased |
|---|---|---|---|---|
| | | Weed numbers | Fresh weight | production |
| Treatment | Dosage | control effect | control effect | rate |
| number | (g/hm²) | (%) | (%) | (%) |
| 1 | 300 | 94 | 95 | 11.8 |
| 2 | 450 | 95 | 96 | 13.2 |
| 3 | 600 | 97 | 97 | 11.9 |

### Application Example B8

### Field Efficacy Test of 30% Clacyfos Microemulsion Against Weeds in Corn Field

The weeds in the test field mainly comprise Amaranthus retroflexus, Ipomoea heperacea and Chen opodium album (L.). Spraying the stems and leaves of the broadleaf weeds at the 3 to 5 leaf stage and the 4 to 6 leaf stage of the corns once, adding water with the amount of 450 liters/hm², and determining the result after 28 days of experiments. The corn experimental variety comprises ‘Weike702’. The 30% clacyfos microemulsion was prepared according to preparation example A6 in the dosage range of 300 g/hm² to 450 g/hm². The results are shown in Table 10.

TABLE 10

| | Weed numbers | Fresh weight |
|---|---|---|
| Dosage (g/hm²) | control effect (%) | control effect (%) |
| 300 | 90.0 | 95.0 |
| 450 | 95.27 | 99.75 |

### Application Example B9

### Safety of 15% and 25% Clacyfos Microemulsion Used in Wheat Fields

The microemulsion of 15% clacyfos (the amount of clacyfos added is 15%, the preparation process is referred to preparation example A3) is in the dosage range of 180 g/hm² to 600 g/hm². The microemulsion of 25% clacyfos (the addition amount of the clacyfos is 25%, the preparation process is referred to preparation example A7) is in the dosage range of 150 g/hm² to 720 g/hm². At various testing areas, clacyfos was used by stems and leaves treatment of wheat field wheat seedlings. The results are shown in Table 11.

TABLE 11

| | Dosage (g/mu) (Increase in production | | | |
|---|---|---|---|---|
| Testing | compared with the control agent (%) | | | |
| area | Clacyfos | | | Control agent |
| Zaoyang | 15% clacyfos | 22.5 g | (16.96%) | 2-methyl-4- |
| | microemulsion | 30 g | (19.72%) | chlorophenoxyacetic |
| | | 37.5 g | (24.85%) | acid 40 g (20.91%) |
| Henan | 25% clacyfos | 20 g | (12.83%) | 2-methyl-4- |
| | microemulsion | 30 g | (19.17%) | chlorophenoxyacetic |
| | | 40 g | (20.89%) | acid 32.5 g (5.51%) |
| | | 50 g | (21.50%) | a certain phytotoxicity |
| | | 75 g | (20.93%) | |
| Hubei | 25% clacyfos | 7.5 g | (11%) | — |
| | microemulsion | 12 g | (10.5%) | |
| | | 24 g | (12.5%) | |
| | | 36 g | (16.1%) | |
| | | 48 g | (17.7%) | |

### Application Example B10

### Herbicide Effect Test of 35% Clacyfos Microemulsion Against Weeds in Paddy Field

The experiment was carried out at the end of July, the weed control of the paddy field (the experimental variety is named as Shaojing 18′) was carried out at the tillering stage of the paddy, and the weed control experiment of the paddy field was respectively carried out by using the 35% clacyfos microemulsion with different dosages for 25 days. The microemulsion of 35% clacyfos (the addition amount of the clacyfos is 25%, the preparation process is referred to preparation example A6) is in the dosage range of 150 g/hm² to 600 g/hm². The results are shown in table 12 and table 13, respectively.

TABLE 12

| | Weed control effect in paddy field (%) 25 days after treatment | | | | | | | | | |
|---|---|---|---|---|---|---|---|---|---|---|
| | | | Ludwigiaprostrata | | | | | | | |
| | Cyperus difformis L. | | Roxb. | | Ammannia arenarid H | | Monochoria vaginalis | | Lindernia procumbens | |
| | Fresh | Weed | Fresh | Weed | Fresh | Weed | Fresh | Weed | Fresh | Weed |
| | weight | numbers | weight | numbers | weight | numbers | weight | numbers | weight | numbers |
| Dosage | control | control | control | control | control | control | control | control | control | control |
| g/hm² | effect | effect | effect | effect | effect | effect | effect | effect | effect | effect |
| 150 | 97 | 95 | 96 | 95 | 97 | 97 | 97 | 100 | 99 | 100 |
| 300 | 99 | 99 | 98 | 98 | 99 | 99 | 98 | 97 | 99 | 99 |
| 450 | 100 | 100 | 100 | 100 | 100 | 100 | 100 | 100 | 100 | 100 |
| 600 | 100 | 100 | 100 | 100 | 100 | 100 | 100 | 100 | 100 | 100 |
| 450 | 97 | 97 | 97 | 96 | 98 | 97 | 97 | 97 | 98 | 98 |
| 5% Clacyfos | | | | | | | | | | |
| EC | | | | | | | | | | |
| 513 | 94 | 94 | 95 | 94 | 96 | 96 | 98 | 98 | 99 | 100 |
| 57% 2,4-D | | | | | | | | | | |
| butyl ester EC | | | | | | | | | | |

TABLE 13

| | Weeds control effect in paddy fields (%) | | |
|---|---|---|---|
| | Weed numbers | Fresh weight | |
| | control effect | control effect | |
| Dosage g/hm² | % | % | Safety |
| 150 | 97 | 97 | No phytotoxicity |
| 300 | 98 | 99 | No phytotoxicity |
| 450 | 100 | 100 | No phytotoxicity |
| 600 | 100 | 100 | No phytotoxicity |
| 450 | 97 | 97 | No phytotoxicity |
| 5% Clacyfos EC | | | |
| 513 | 96 | 97 | No phytotoxicity |
| 57% 2,4-D butyl | | | |
| ester EC | | | |

The investigation results (see table 12 and table 13) after the pesticide was applied for 25 days show that the weed numbers control effect and the fresh weight control effect on the total grass under the treatment of the 35% clacyfos microemulsion with the dosage of 150 g/hm² to 450 g/hm² are 97% to 100%, and the weed numbers control effect and the fresh weight control effect under the treatment of the dosage of 300 g/hm² to 450 g/hm² are superior to those of the total grass of 5 weeds under the treatment of the control agent 5% clacyfos EC with the dosage of450 g/hm² and 57% 2,4-D butyl ester EC with the dosage of513 g/hm². The 35% clacyfos microemulsion with the dosage of 150 g/hm² to 450 g/hm² is safe to the growth of rice.

### Application Example B11

### Herbicide Effect Test of 45% Clacyfos Microemulsion Against Weeds in Paddy Field

The experiment was carried out in August, the paddy field weeds were controlled after 4leafperiod of rice (experimental variety: Shaojing 18′), the paddy field weeds were controlled by using 45% clacyfos microemulsion with different dosages, and the treatment results are counted 28 days after the application. 45% clacyfos microemulsion (the addition amount of the clacyfos is 45%, the preparation refers to preparation example A4) is in the dosage range of 300 g/hm² to 600 g/hm². The results are shown in table 14 and table 15, respectively.

TABLE 14

| | Weed control effect in paddy fields (%) 28 days after treatment | | | | | | | | | |
|---|---|---|---|---|---|---|---|---|---|---|
| | | | Ludwigiaprostrata | | | | | | | |
| | Cyperus difformis L. | | Roxb. | | Ammannia arenarid H | | Monochoria vaginalis | | Lindernia procumbens | |
| | Fresh | Weed | Fresh | Weed | Fresh | Weed | Fresh | Weed | Fresh | Weed |
| | weight | numbers | weight | numbers | weight | numbers | weight | numbers | weight | numbers |
| Dosage | control | control | control | control | control | control | control | control | control | control |
| g/hm² | effect | effect | effect | effect | effect | effect | effect | effect | effect | effect |
| 300 | 97 | 97 | 97 | 95 | 99 | 98 | 97 | 97 | 99 | 99 |
| 450 | 100 | 99 | 100 | 99 | 100 | 99 | 100 | 98 | 100 | 100 |
| 600 | 100 | 100 | 100 | 100 | 100 | 100 | 100 | 100 | 100 | 100 |
| 450 | 97 | 97 | 97 | 97 | 98 | 97 | 97 | 97 | 98 | 98 |
| 5% Clacyfos | | | | | | | | | | |
| EC | | | | | | | | | | |
| 513 | 94 | 94 | 95 | 94 | 95 | 96 | 98 | 98 | 99 | 100 |
| 57% 2,4-D | | | | | | | | | | |
| butyl ester EC | | | | | | | | | | |

TABLE 15

| | Weeds control effect in paddy fields (%) | | |
|---|---|---|---|
| | 28 days after treatment | | |
| | Weed numbers | Fresh weight | |
| | control effect | control effect | |
| Dosage g/hm² | % | % | Safety |
| 300 | 97 | 98 | No phytotoxicity |
| 450 | 99 | 100 | No phytotoxicity |
| 600 | 100 | 100 | No phytotoxicity |
| 450 | 97 | 97 | No phytotoxicity |
| 5% Clacyfos EC | | | |
| 513 | 96 | 97 | No phytotoxicity |
| 57% 2,4-D butyl | | | |
| ester EC | | | |

The investigation results (see table 14 and table 15) after the pesticide was applied for 28 days show that the weed numbers control effect and the fresh weight control effect on the total grass under the treatment of the 45% clacyfos microemulsion with the dosage of 300 g/hm² to 450 g/hm² are 97% to 100%, and the weed numbers control effect and the fresh weight control effect under the treatment of the dosage of 450 g/hm² are both better than those of the total grass of 5 weeds under the treatment of the control agent 5% clacyfos EC with the dosage of 450 g/hm² and 57% 2,4-D butyl ester EC with the dosage of 513 g/hm², The 45% clacyfos microemulsion with the dosage of 150 g/hm² to 450 g/hm² is safe to the growth of rice.

### Application Example B12

### Clacyfos Weeding Spectrum

Combining the results of indoor and field tests of clacyfos, the herbicidal spectrum of clacyfos can be summarized as follows:

Dicotyledonous and sedge weeds which can be effectively controlled under the recommended dosage of 450 g/hm² are:

Veronica dyma Tenore; Galium aparine L. var. tenerum (gren. Et Godr) Rc bb; Capsella bursa-pastoris (L.) Medic; Descurainia Sophia (L.) Schur; Stellaria media (L.) Cyr.; Mala chiaum aquaticnm (L.) Fries; Chenopodium album (L.); Trigonotis peduncularis (TreV.) Benth; Vicia sativa L.; Hemistepta lura Bge; Lapsana apoqonoides Maxim; Geranium carolinium L.; Lamium amplexi-caule L.; Brassica napus L. or Brassica canpesris; Amaranthus retroflectus L.; Portulaca oleracea; Abutilon theothrorsti; Amaranthus retroflexus; Ipomoea heperacea; Sinapis alba; Cirsium japonicum DC; Cephalanoploris segetum; Achyranthus bidenta Bl.; Acalypha australis L.; Cayratia joponica; Duchesen indica Focke; Humulus scandens Merr; Oxalidis eornidilta; Polygonum perfoliatum L.; Mazus japonicus; Physalis angulates, Cyperus rotundus; Erigereron bonariensis; Artemisia annua; Polygonum aviculare; Kummerowia striata; Mollliugo pentaphylla; Amaranthus viridis; Eclipta prostrata; Polygonum lapathifolium; Conyza canadensis; Erigeron annuus; Medicago sativa; Polygonum amphenium; Artemisia vulgaris; Rotala indica; Lindernia procumbens; Alternanthera philoxeroides; Amaranthus ascendens; Ludwigia prostrata Roxb; Cyperus difformis L.; Juncellus serotinus; Ammannia arenaria H.; Monochoria vagina (Burro. f.) Presl; Mllrdanniatriguetra (Wal1.) Brijckn.

Under the dosage of 700 g/hm² to 800 g/hm², the monocotyledonous weeds which can be controlled by the clacyfos are as follows:

Echinochloa crusgalli Beava; Digitaria Sanguinalis scop; Alopecurus aequalis; Alopecurus japonicus steud; Setaria viridis; Cynodon dactylon; Eleusine indica; Leptochloa chinensis; Arthraxon hispidus; Eleusine indica; Imperata cyllndrlca; Cyperus difformis; Cyperus iria; Kyllinga brevifolia; Poa cnnua; Monochoria vaginalis; Potamogeton distinctus; Sagittaria pygmaea; Cyperus iria; Eleocharis yokoscensis; Digitaria adscendens; Equisetum arvenense. The results for the inhibitory activity ofclacyfos against 22 plants or weeds are shown in Table 16.

TABLE 16

| Plant category | Scientific name | Visual activity % | Sensitivity |
|---|---|---|---|
| Brassica | Brassica | 100 | Highly |
| campestris | campestris | | sensitive |
| Amaranthus | Amaranthus | 100 | |
| rebroflexus L. | rebroflexus L. | | |
| Brassica pekinensis | Brassica pekinensis | 100 | |
| Herba Cirsii | Herba Cirsii | 100 | |
| Jeponici | Jeponici | | |
| Ipomoea heperacea | Ipomoea heperacea | 100 | |
| Amaranthus | Amaran thus | 100 | |
| retroflexus | retroflexus | | |
| Eclipta prostrata L. | Eclipta prostrata L. | 100 | |
| Eleusine indica (L.) | Eleusine indica (L.) | 100 | |
| Gaertn | Gaertn | | |
| Chenopodium | Chenopodium | 100 | |
| album L. | album L. | | |
| Daucus carota L. | Daucus carota L. | 100 | |
| Beta Vulgaris | Beta Vulgaris | 95 | Very |
| Sinapis alba | Sinapis alba | 95 | sensitive |
| Medicago saliva | Medicago saliva | 90 | Sensitive |
| Cyperus microiria | Cyperus microiria | 90 | |
| Abutilontheophrasti | Abutilontheophrasti | 85 | |
| Medicus | Medicus | | |
| Rumex crispus L. | Rumex crispus L. | 80 | |
| Galium aparine | Galium aparine | 60 | Generally |
| Setaria viridis(L.) | Setaria viridis(L.) | 50 | sensitive |
| Beauv | Beauv | | |
| Poa annua L. | Poa annua L. | 50 | |
| Digitaria | Digitaria | 40 | |
| sanguinalis(L.) | sanguinalis(L.) | | |
| Scop | Scop | | |
| Echinochloa | Echinochloa | 30 | |
| crusgalli (L.) | crusgalli (L.) | | |
| Alopecurus | Alopecurus | 0 | Resistance |
| aequalis Sobol | aequalis Sobol | | |

### Application Example B13

The herbicidal activity of 30% clacyfos microemulsion against plants in different leaf ages was determined at a dosage of 450 g/hm². The 30% clacyfos microemulsion was prepared according to the preparation example A9. The results are shown in Table 17.

TABLE 17

| | Brassica | | Amaranthus | | Echinochloa | | Digitaria | |
|---|---|---|---|---|---|---|---|---|
| | campestris | | rebroflexus L. | | crusgalli (L.) | | sanguinalis(L.) Scop | |
| | | Weed | | Weed | | Weed | | Weed |
| | | numbers | | numbers | | numbers | | numbers |
| | Fresh | control | Fresh | control | Fresh | control | Fresh | control |
| | weight | effect | weight | effect | weight | effect | weight | effect |
| Plant seedling age | (mg) | (%) | (mg) | (%) | (mg) | (%) | (mg) | (%) |
| Before germination | 0 | 100 | 0 | 100 | 15.0 | 60.8 | 8.8 | 80.3 |
| Cotyledon or needle | 0 | 100 | 0 | 100 | 21.3 | 48.5 | 19.3 | 56.9 |
| stage | | | | | | | | |
| 1 to 2 true leaf stage | 0 | 100 | 0 | 100 | 36.0 | 27.7 | 39.0 | 27.1 |
| 3 to 4 true leaf stage | 0 | 100 | 0 | 100 | 102.5 | 22.1 | 70.3 | 16.8 |
| 5 to 6 true leaf stage | 0 | 100 | 0 | 100 | 207 | 24.3 | 82.5 | 13.0 |

### Application Example B14

### Clacyfos Absorption and Conduction Experiment

To clarify the absorption and conduction characteristics of the clacyfos, and its mode of action, the absorption and action parts of clacyfos were measured by the method of stem coating, leaf coating and root irrigation. Amaranthus retroflexus was used as an experimental material. The results were measured 12 days after the experiment. The 30% clacyfos microemulsion was prepared according to preparation example A8, and the dosage range is 300 g/hm² to 600 g/hm². The results are shown in Table 18.

TABLE 18

| | Root length | Inhibition rate of | Mean fresh |
|---|---|---|---|
| Treatment | inhibition rate | aboveground plants | weight |
| method | (visual inspection) | (visual inspection) | inhibition rate |
| Leaf coating | 100% | 100% | 100% |
| Stem coating | 60% | 85% | 89.60% |
| Root | 90% | 100% | 100% |
| irrigation | | | |

The preferred embodiments of the present invention have been described above in detail, but the present invention is not limited thereto. Within the scope of the technical idea of the invention, a variety of simple variations of the technical scheme of the invention can be made, including various technical features being combined in any other suitable way, and these simple modifications and combinations should also be regarded as the disclosure of the invention, and all fall within the scope of the invention.

1. The microemulsion formulation containing the clacyfos herbicideis characterized by containing clacyfos, an environment-friendly solvent and a surfactant, wherein the microemulsion formulation has a particle radius of 0.01 μm to 0.1 μm and a pH value of 5 to 7.

2. The microemulsion formulation as claimed in claim 1, wherein the content of clacyfos is 10 wt % to 80 wt %.

3. The microemulsion formulation as claimed in claim 1, wherein the environment-friendly solvent comprises water and an organic solvent selected from at least one of vegetable oil solvents, coal tar cracking products, petroleum cracking solvents and synthetic environment-friendly solvents.

4. The microemulsion formulation as claimed in claim 3, wherein the organic solvent is selected from at least one of biodiesel, solvent oil, liquid paraffinoil, deodorized kerosene, straight-chain alkanes, dimethyl carbonate, N-methylpyrrolidone, propylene glycol methyl ether, cyclohexanone, and ethylene glycol.

5. The microemulsion formulation as claimed in claim 1, wherein the surfactant is selected from at least one of alkyl sulfonates, alkylaryl sulfonates, alkyl sulfates, polyethers, alkylaryl ethers, polyoxyethylene derivatives, polyethylene glycol ethers, sorbitol monooleate derivatives, polyhydric alcohol esters and sugar alcohol derivatives.

6. The microemulsion formulation as claimed in claim 1, which further contains a synergist selected from at least one of silicones, esterified vegetable oils, esterified polyoxyethylene glycerols, methylated polyoxyethylene fatty acids, ethoxylated castor oils, ethoxylated fatty amines, tallow amine polyoxyethylene esters, polycarboxylates, alkyl naphthalene sulfonates, phosphate esters, carboxylic copolymers, comb polymers, fatty alcohol polyoxyethylene ethers and phosphate amine salts.

7. A method of preparing the microemulsion formulation of claim 1, comprising: mixing and stirring the clacyfos, the environment-friendly solvent, the surfactant and the optional synergistic additive to form transparent homogeneous liquid, and then adjusting the pH value to 5 to 7.

8. Use of the microemulsion formulation according to claim 1 for the control of agricultural weeds.

9. The use as claimed in claim 8, wherein the amount of the clacyfos is 150 g/hm² to 800 g/hm².

10. The use as claimed in claim 8, wherein the agricultural weeds are weeds of gramineous crops such as gramineous lawns, wheat, corn, rice, and orchards, tea gardens, and uncultivated areas.

11. The use as claimed in claim 10, wherein the agricultural weeds are Descurainia Sophia(L.) Schur, Lapsana apoqonoides Maxim, Ranunculus japonicus Thunb., Polygonum capitatumBuch.-Ham. ex D. Don, Polygonum aviculare, Polygonum hydropiper L., Chen opodium album (L.), Amaranthus rebroflexus L., Portulaca oleracea, Acalypha australis L., Parthenocissus tricuspidata(Sieb. & Zucc.) Planch., Abutilon theophrasti, Eclipta prostrata, Mala chium aquaticnm (L.) Fries, Amaranthus ascendens, Amaranthus retroflexus, Commelina communis, Cephalanoplos segetum, Ipomoea heperacea, Pharbitispurpurea (L.) Voisgt, Mazus japonicus, Potentilla supina L., Cyperus difformis L., ElsholtziaWilld, Erigeronbonariensis, Amaranthus spinosus L., Brassica juncea(L.) Czern. et Coss., Eclipta prostrata, Polygonum, Chenopodium serotinumL., Vicia sativa L., Cyperus iria, Leptochloachinesis, Alternanthera philoxeroidis, Humulus scandens Merr, Euphorbia maculate L., Rotala indica, Ammannia rotundifolia Roxb, Lindernia procumbens, Xanthium sibiricum Patrin ex Widder, Convolvulus arvensis L., Eclipta prostrata, Juncellus serotinus, Ludwigiaprostrata Roxb Ammannia arenarid H., Ammannia baccifera L., Monochoria vaginalis, Mllrdanniatriguetra (Wal1.) Brijekn, Cayratia japonica, Duchesen indica Focke, Cirsium japonicum, Achyranthes bidentata Bl., Amaranthus retroflexus, Capsella bursa-pastoris (L.) Medic, Cyperusrotundus, Polygonum perfoliatum L., Artemisia annua, Arthraxon hispidus, Sagittaria pygmaea, Alisma plantago-aquaticaLinn., Sagittaria trifolia L., Marsilea quadrifolia L., Potamogeton distinctus, Spirodela polyrhiza(L) Schleid. Lemna polyrhiza L., Fimbristylis miliacea (L) Vahl, Galium aparine L. Var. tenerum (Gren. Et Godr) Rc bb, Euphorbia helioscopia L., Veronica didyma Tenore, Buglossoides arvense, Silene conoidea L., Lamium amplexi-caule L., Geranium Carolinianum L., Hemistepta lyrataBge, Solanum nigrum L., Physalis angulata, Origanum vulgare L., Physalis angulata, Eleusine indica, Imperata cyllndrlca, Digitaria Sanguinalis scop, Equisetum arvenense.

12. The microemulsion formulation as claimed in claim 1, wherein the content of clacyfos is 25 wt % to 75 wt %.

13. The microemulsion formulation as claimed in claim 2, wherein the environment-friendly solvent comprises water and an organic solvent selected from at least one of vegetable oil solvents, coal tar cracking products, petroleum cracking solvents and synthetic environment-friendly solvents.

14. The microemulsion formulation as claimed in claim 2, wherein the surfactant is selected from at least one of alkyl sulfonates, alkylaryl sulfonates, alkyl sulfates, polyethers, alkylaryl ethers, polyoxyethylene derivatives, polyethylene glycol ethers, sorbitol monooleate derivatives, polyhydric alcohol esters and sugar alcohol derivatives.

15. The microemulsion formulation as claimed in claim 2, which further contains a synergist selected from at least one of silicones, esterified vegetable oils, esterified polyoxyethylene glycerols, methylated polyoxyethylene fatty acids, ethoxylated castor oils, ethoxylated fatty amines, tallow amine polyoxyethylene esters, polycarboxylates, alkyl naphthalene sulfonates, phosphate esters, carboxylic copolymers, comb polymers, fatty alcohol polyoxyethylene ethers and phosphate amine salts.

16. The use as claimed in claim 8, wherein the amount of the clacyfos is 300 g/hm² to 600 g/hm².
